(19) United States
(12) Patent Application Publication
(10) Pub. No.: US 2026/0244258 A1
(43) Pub. Date: Aug. 20, 2026

(54) TIME- AND LOCATION-BASED CONTENT DELIVERY SYSTEM

(71) Applicant: CAPITAL ONE SERVICES, LLC, McLean, VA (US)

(72) Inventor: Bryan TAMAYO, Allen, TX (US)

(21) Appl. No.: 19/058,617

(22) Filed: Feb. 20, 2025

(51) Int. Cl. G06F 3/01; G06F 9/451

(52) U.S. Cl. CPC G06F 3/011; G06F 9/454

(57) ABSTRACT

In some implementations, a system may receive coarse location information based on a user device being in an activation zone. The system may receive fine location information based on a determination of at least one of a proximity event or an interaction event occurring in a proximity zone within the activation zone. The system may obtain decision information indicating one or more conditions for selecting one or more content elements according to at least one of the coarse location information or the fine location information, wherein the decision information is associated with one or more respective time stamps for the coarse location information and the fine location information. The system may select one or more content elements according to the decision information. The system may provide the selected one or more content elements to the user device.

### BACKGROUND

An individual may provide people, or computing devices, with information regarding a location of the individual for a variety of reasons. Location data may be used to track an individual associated with a computing device, and the location data may be stored with the computing device or may be transmitted to another computing device. The computing device may include one or more components capable of identifying a location of the computing device (e.g., a global positioning system (GPS) component) to determine the geographic location of the computing device.

### SUMMARY

Some implementations described herein relate to a system for time-and location-based content delivery. The system may include one or more memories and one or more processors communicatively coupled to the one or more memories. The one or more processors may be configured to receive coarse location information associated with a user based on a user device, associated with the user, being in an activation zone, wherein the coarse location information includes geolocation information associated with the user device. The one or more processors may be configured to receive fine location information associated with the user based on a determination of at least one of a proximity event or an interaction event, occurring in a proximity zone of one or more proximity zones located within the activation zone, wherein the proximity event is determined based on one or more proximity measurements between the user device and one or more detectors satisfying a proximity condition, wherein the interaction event is determined based on an interaction between a user tag, associated with the user, and one or more beacons. The one or more processors may be configured to obtain decision information indicating one or more conditions for selecting one or more content elements from a set of content elements according to at least one of the coarse location information or the fine location information, wherein the decision information is associated with one or more respective time stamps for the coarse location information and the fine location information. The one or more processors may be configured to select one or more content elements from the set of content elements according to the decision information. The one or more processors may be configured to provide the selected one or more content elements, via a user interface, to the user device.

Some implementations described herein relate to a method for time-and location-based content delivery. The method may include receiving, by a system, coarse location information associated with a user based on a user device, associated with the user, being in an activation zone, wherein the coarse location information includes geolocation information associated with the user device. The method may include receiving, by the system, fine location information associated with the user based on a determination of at least one of a proximity event or an interaction event, occurring in a proximity zone of one or more proximity zones located within the activation zone, wherein the proximity event is determined based on one or more proximity measurements between the user device and one or more detectors satisfying a proximity condition, wherein the interaction event is determined based on an interaction between a user tag, associated with the user, and one or more beacons. The method may include obtaining, by the system, decision information indicating one or more conditions for selecting one or more content elements from a set of content elements according to at least one of the coarse location information or the fine location information, wherein the decision information is associated with one or more respective time stamps for the coarse location information and the fine location information. The method may include selecting, by the system, one or more content elements from the set of content elements according to the decision information. The method may include providing, by the system, the selected one or more content elements, via a user interface, to the user device.

Some implementations described herein relate to a non-transitory computer-readable medium that stores a set of instructions. The set of instructions, when executed by one or more processors of a system, may cause the system to receive coarse location information associated with a user based on a user device, associated with the user, being in an activation zone, wherein the coarse location information includes geolocation information associated with the user device. The set of instructions, when executed by one or more processors of the system, may cause the system to receive fine location information associated with the user based on a determination of at least one of a proximity event or an interaction event, occurring in a proximity zone of one or more proximity zones located within the activation zone, wherein the proximity event is determined based on one or more proximity measurements between the user device and one or more detectors satisfying a proximity condition, wherein the interaction event is determined based on an interaction between a user tag, associated with the user, and one or more beacons. The set of instructions, when executed by one or more processors of the system, may cause the system to obtain decision information indicating one or more conditions for selecting one or more content elements from a set of content elements according to at least one of the coarse location information or the fine location information, wherein the decision information is associated with one or more respective time stamps for the coarse location information and the fine location information. The set of instructions, when executed by one or more processors of the system, may cause the system to select one or more content elements from the set of content elements according to the decision information. The set of instructions, when executed by one or more processors of the system, may cause the system to provide the selected one or more content elements, via a user interface, to the user device.

### BRIEF DESCRIPTION OF THE DRAWINGS

FIGS. 1A-1D are diagrams of an example associated with time-and location-based content delivery, in accordance with some embodiments of the present disclosure.

FIG. 2 is a diagram of examples associated with time-and location-based content delivery, in accordance with some embodiments of the present disclosure.

FIG. 3 is a diagram of an example of training and using a machine learning model in connection with a time-and location-based content delivery system, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with time-and location-based content delivery, in accordance with some embodiments of the present disclosure.

FIG. 6 is a flowchart of an example process associated with time-and location-based content delivery, in accordance with some embodiments of the present disclosure.

### DETAILED DESCRIPTION

The following detailed description of example implementations refers to the accompanying drawings. The same reference numbers in different drawings may identify the same or similar elements.

Location data may be used to track an individual in a stationary location and/or as the location of the user changes. For example, location data may be used to track an individual associated with a computing device. In some cases, the computing device may include one or more components capable of identifying a location of the computing device (e.g., a global positioning system (GPS) component) to determine the geographic location of the computing device. Additionally, location data may be used in a geofencing technology, which uses virtual boundaries around a specific geographic area and triggers predefined actions when location data indicates that an individual is located within or outside of the geographic area. Furthermore, location data may be used in determining content to serve to a user. For example, the location of an individual (e.g., via a GPS-reported location of a computing device associated with the user) may be used by an internet search engine to provide search results that are localized to the user's location.

However, location data may be tracked via a single method, such as geofencing, short-range wireless technology (e.g., Bluetooth, WiFi, or the like), or near-range communication (e.g., near-field communication (NFC), ). For example, geofencing may enable broad location tracking, but may lack precision and/or accuracy in indoor or congested environments (e.g., environments having a relatively high number of computing devices being tracked in a geographic area). Similarly, short-range wireless technologies may enable location determination on a relatively localized scale, but may only provide general proximity data and may fail to facilitate personalized interactions. Furthermore, near-range communications enable touchpoint interactions, but such communications are limited to physical contact and may be unable to provide uninterrupted tracking across relatively large geographic areas or to provide dynamic, personalized experiences.

Additionally, location data may be tracked using standalone GPS-or WiFi-based tracking of computing devices associated with an individual. Although such approaches may enable broader tracking coverage (e.g., a greater range of tracking in an environment), these approaches may lack localized precision in indoor or congested environments. Similarly, these approaches may lack personalized interactivity with points of interest. For example, such GPS-or WiFi-based tracking systems may rely solely on manual user input (e.g., via a computing device associated with the individual, via a stationary computing device located at a point of interest, or the like). For example, a content delivery system may rely on a user to interact with a user interface (UI) in order to obtain personalized and/or customized content, which may result in user friction (e.g., hindering a user's ability to efficiently and effectively achieve an objective via the UI), increased resource usage, and delayed adaptability.

Some implementations described herein enable dynamic content delivery based on a time and a location associated with a user. For example, content elements may be delivered to a user device based on a determined location of a user. In some implementations, a system may receive coarse location information and fine location information associated with a user, obtain decision information indicating conditions for selecting content elements, select one or more content elements according to the decision information, and provide the selected content elements to a user device associated with the user. In some implementations, the coarse location information is associated with a user device associated with the user being in an activation zone, and may include geolocation information associated with the user device. In some implementations, the fine location information may be associated with at least one of a proximity event or an interaction event, occurring in a proximity zone of one or more proximity zones located within the activation zone. In some implementations, the proximity event is determined based on one or more proximity measurements between the user device and one or more detectors satisfying a proximity condition. In some implementations, the interaction event is determined based on an interaction between a user tag, associated with the user, and one or more beacons. Additionally, the system may track the user based on the coarse location information and fine location information in order to generate vector data (e.g., path data, movement data, behavior data, or the like) that may be utilized to obtain updated decision information. Furthermore, the system may generate behavior information based on the tracking of the user, obtain predicted path and/or behavior information associated with the user, obtain updated decision information based on the predicted path and/or behavior information, and select an updated one or more content elements based on the updated decision information.

As a result, the system may deliver content that is customized to a user's location at a certain time and may be personalized to the user. Furthermore, by utilizing a layered, integrated approach to determining a user location, the described techniques may improve accuracy and precision and reduce latency for determining user location. For example, the layered, integrated architecture may enable seamless transitions of user tracking across broad geographic areas, micro-locations, and precise interaction points of interest, without loss of context or performance. Accordingly, by accurately and continuously monitoring users across multiple zones, the system may reduce resource usage (e.g., network resources, power resources, or the like) relative to periodic and/or discontinuous tracking that may require the system to repeatedly identify, acquire, and/or reacquire users.

Similarly, by adapting and delivering content based on a movement path and/or behavior information associated with the user over a period of time, the system may deliver unique, location-specific content to the user at different points along a movement path and/or according to a predicted movement path. Furthermore, by utilizing time stamp information associated with a user's location (e.g., including coarse location information and fine location information), the system may allocate resources more efficiently by obtaining and providing content information to a user only when the time stamp information satisfies certain conditions (e.g., when points of interest are open and/or are associated with relatively low congestion levels, among other examples).

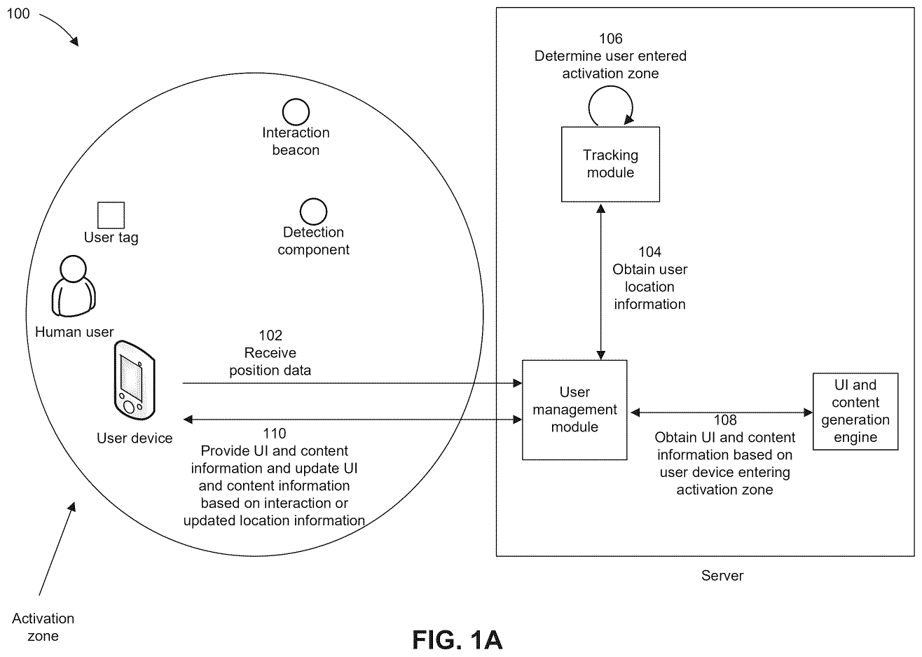

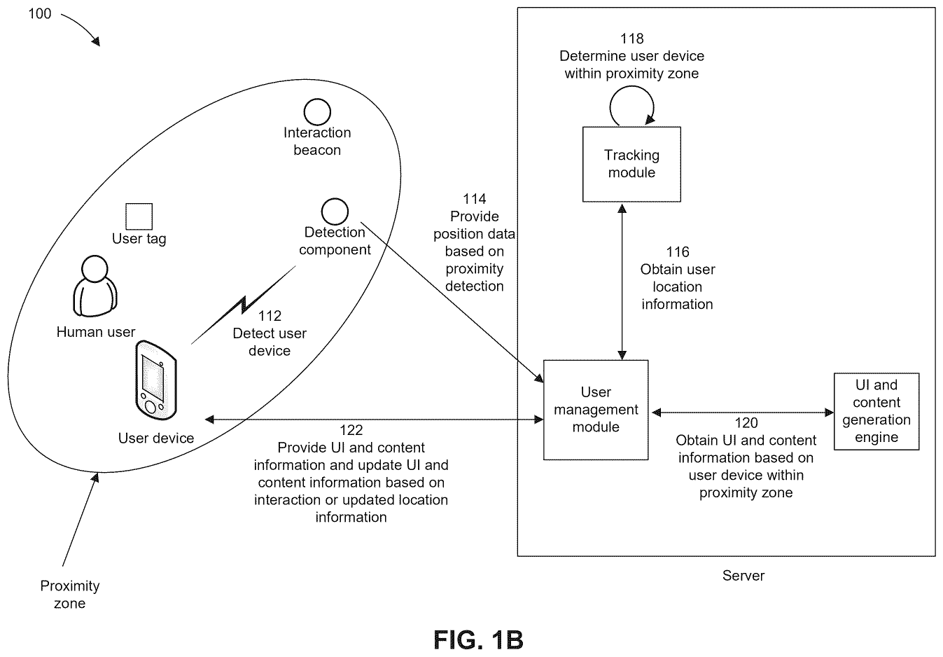

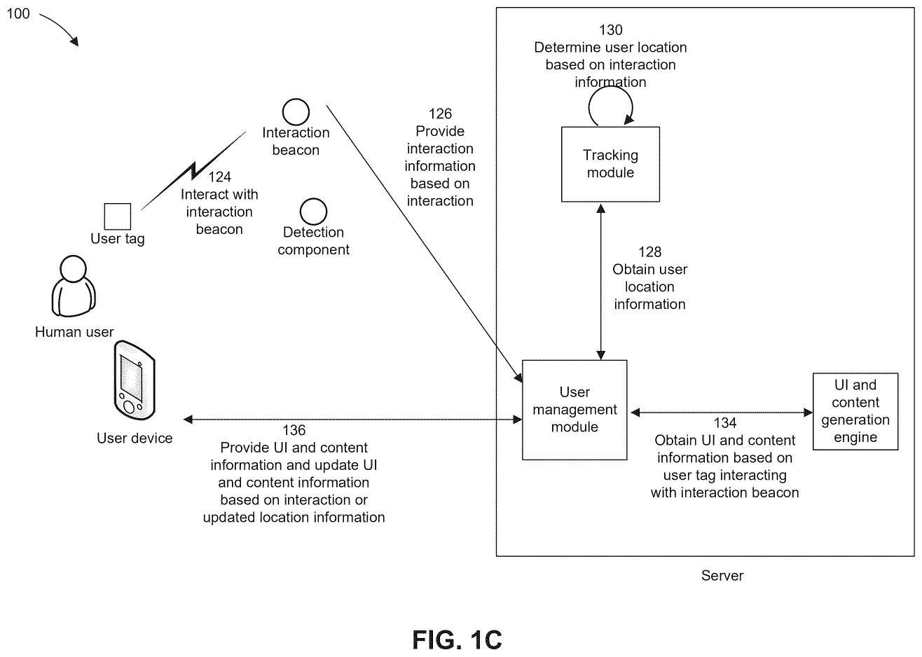

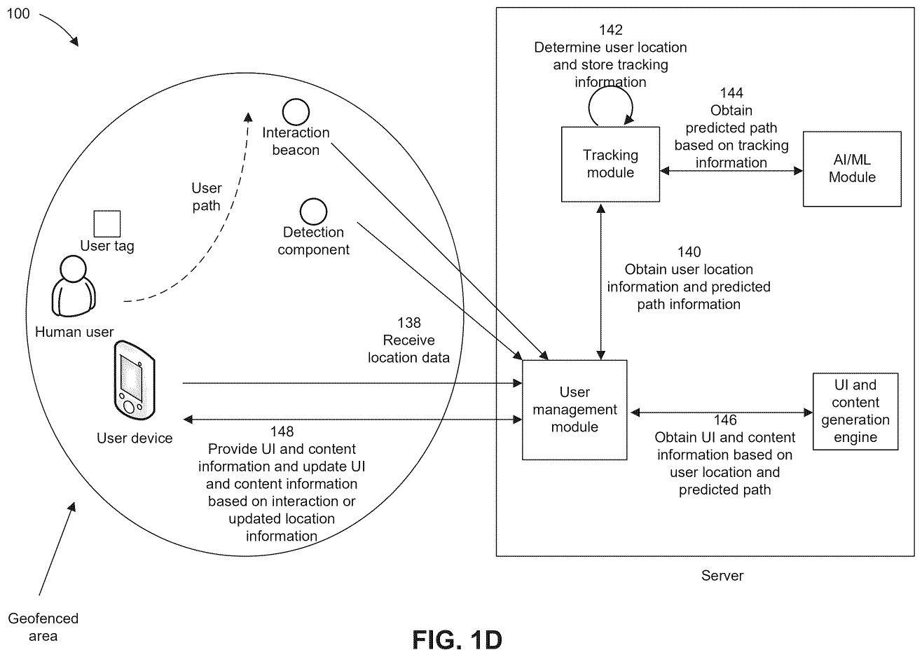

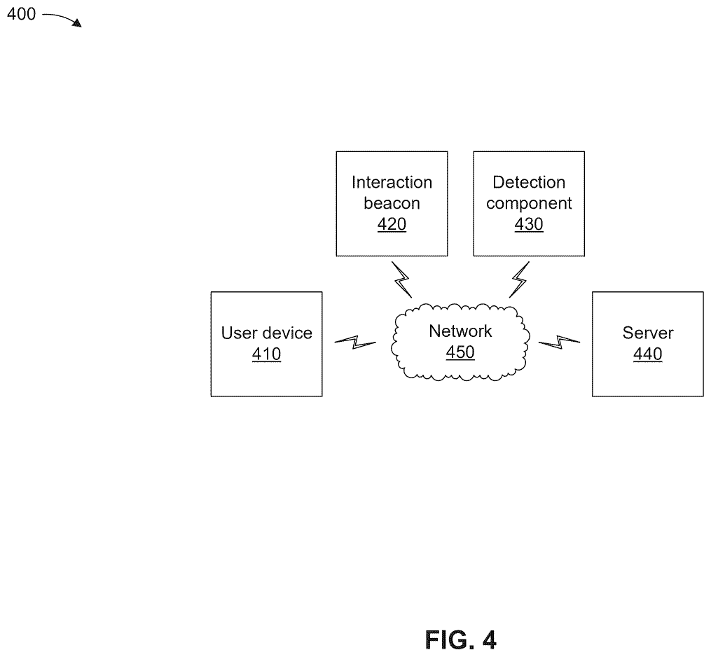

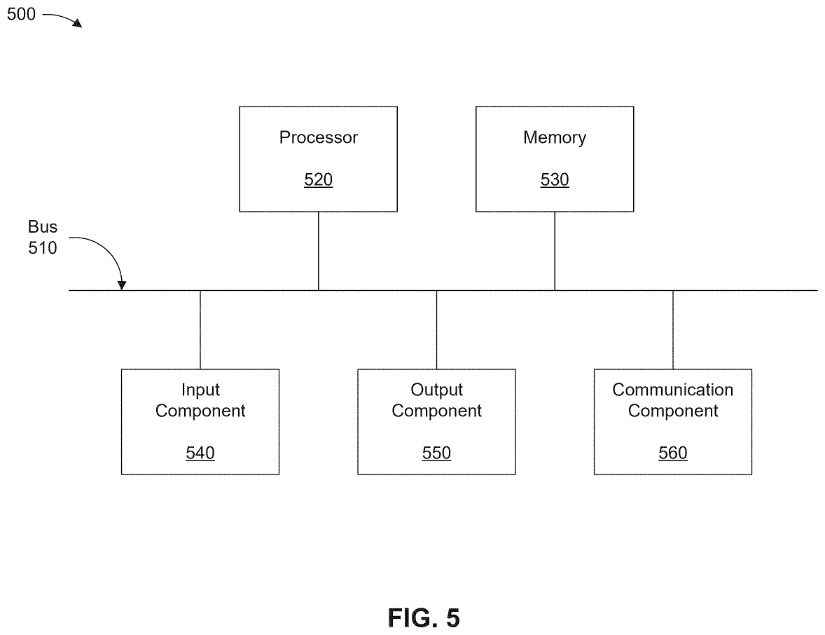

FIGS. 1A-1D are diagrams of an example 100 associated with time-and location-based content delivery. As shown in FIGS. 1A-1D, example 100 includes a user device, an interaction beacon, a detection component, and a server. These devices are described in more detail in connection with FIGS. 4 and 5.

As shown in FIG. 1A, the described techniques may be utilized to determine a location of a user associated with a user device. For example, the described techniques may be utilized to determine whether the user device has entered an activation zone. As shown by reference number 102, a user management module may receive position data for the user device associated with the user. In some implementations the position data may include coarse location information. For example, the coarse location information may include geolocation information (e.g., GPS, global navigation satellite system, BeiDou navigation satellite system, Galileo satellite system, or the like). In some implementations, the coarse location information may indicate that the user device is located within the activation zone based on the user device being located within a geofenced area associated with the activation zone. For example, GPS data associated with the user device may indicate that the user is located within a geofenced area associated with the activation zone. Additionally, or alternatively, the coarse location data may be associated with time stamp information for the user's location at a specific time and/or within a specific time period.

As shown by reference number 104, the user management module may obtain user location information from a tracking module. In some implementations, the tracking module may utilize the position data, received from the user device, to determine user location information. As shown by reference number 106, the tracking module may determine that the user has entered the activation zone from an area that is outside of the activation zone. In some examples in which the user enters a geofenced area associated with the activation zone, the tracking module may determine that the user has entered the geofenced area based on the position data (e.g., coarse location data) received from the user device. Additionally, or alternatively, the tracking module may determine and/or provide location information associated with the user's dynamic, changing position within the activation zone. For example, in a scenario in which the user is moving through the geofenced area, the tracking module may utilize position data, received via the user device, to determine the user's location within the geofenced area over a period of time.

As shown by reference number 108, the user management module may obtain, from a UI and content generation engine, a UI and/or content information based on the user location information. In some implementations, the user management module may obtain the UI and/or content information based on determining that the user device associated with the user has entered the activation zone. In some examples in which the user enters a geographic area associated with a campus (e.g., a school campus, corporate campus, retail shopping campus, transportation hub, or the like), the user management module may select content and the UI that provides content relevant to the user entering the campus (e.g., a message indicating “Welcome to Campus.”). Additionally, or alternatively, time stamp information may be utilized to obtain content information that is relevant to the time of day associated with a user location. For example, in a scenario in which the user enters the campus in the morning, the user management module may obtain content information that provides content relevant to the user entering at that time of day (e.g., a message indicating “Welcome to Campus! Breakfast specials are ending soon at the café.”). Furthermore, by utilizing time stamp information associated with the user's location (e.g., including coarse location information and fine location information, as described herein), the system may allocate resources more efficiently by obtaining and providing content information to a user only when the time stamp information satisfies certain conditions. For example, in a scenario in which the user is in relatively close proximity to the campus café, the system may only provide content information to the user during time periods when the campus café is open.

As shown by reference number 110, the user management module may provide, and the user device may receive, the UI and content information (e.g., activation content) obtained from the UI and content generation engine. For example, the UI may be configured for and/or adapted to the type of user device (e.g., mobile device, smartwatch, tablet, or the like) associated with the user. Similarly, the content information may include content (e.g., text, images, graphics, interactive content elements, and/or videos, among other examples) that is relevant to the user entering the activation zone and/or may include content that is relevant to the user's location within the activation zone.

In some implementations in which the user management module receives updated position data associated with the user, the user management module may obtain updated content information based on the updated position data. For example, in a scenario in which the user management module receives updated position data indicating that the user is moving away from the perimeter of the activation zone (e.g., moving toward a centermost point of the activation zone), the user management module may obtain updated content intended to encourage the user's interaction with specific areas and/or points of interest within the activation zone.

In some implementations, a user device hub (e.g., a mobile application, web application, and/or web page, among other examples) may be associated with the user device, and the user device hub may aggregate the position data for reporting to the user management module and/or may receive UI information and/or content information from the user management module. Additionally, or alternatively, the user device hub may be configured to receive user input and provide the user input to the user management module.

Additionally, or alternatively, the described techniques may be utilized to provide content information and update content information based on the user's location within an activation area in combination with the user's location within a proximity zone and/or the user's interaction with an interaction beacon, as described herein.

As shown in FIG. 1B, the described techniques may be utilized to determine fine location information associated with a user based on a proximity event. For example, the described techniques may be utilized to determine whether a user device associated with a user is located within a proximity zone. In some implementations, the described techniques may be utilized to determine a proximity event based on one or more proximity measurements between the user device and one or more detection components. Furthermore, the described techniques may be used to determine fine location information associated with the user based on a proximity event occurring in a proximity zone. In some implementations, the proximity zone may be located within the activation zone (e.g., a geofenced area).

As shown by reference number 112, a detection component may detect the user device within a proximity zone associated with the detection component. For example, in some implementations, the detection component may emit a passive and/or active wireless signal, thereby enabling the detection component to detect the user device utilizing a short-range wireless technology standard (e.g., Bluetooth, Zigbee, or the like). As shown by reference number 114, the detection component may provide, and the user management module may receive, position data based on the detection of the user device within the proximity zone. As shown by reference number 116, the user management module may obtain user location information from a tracking module. In some implementations, the tracking module may utilize the position data, received from the detection component, to determine user location information.

As shown by reference number 118, the tracking module may determine the user's location based on the position data provided from the detection component. In some implementations, the tracking module may determine that the user device is located within the proximity zone associated with the detection component. Additionally, the tracking module may determine fine location information associated with the user based on the determination of a proximity event occurring within the proximity zone.

In some implementations, the proximity event may be determined based on one or more proximity measurements, between the user device and one or more detectors, satisfying a proximity condition. For example, in a scenario in which the detection component provides proximity measurement information indicating that the distance between the user device and the detection component satisfies (e.g., meets or is less than) a threshold, the tracking module may determine that the user device is within the proximity zone. Additionally, or alternatively, the proximity measurement information may include a directional component, and the proximity zone may be bounded by one or more distance measurements and one or more vectors projecting from the detection component. For example, in a scenario in which the detection component is located near a wall or similar obstruction, a detection antenna may be positioned to monitor for user devices located in a direction opposite to the wall, thereby preventing unproductive usage of monitoring resources.

In some implementations, the proximity zone may be associated with a known geographic location, thereby enabling the location of the user to be determined based on the user device's proximity to the detection component within the proximity zone. For example, the detection component may be located at a campus café, thereby enabling the user location to be determined as in proximity to the campus café, based on a proximity measurement relative to the detection component. Accordingly, by determining that the user is located within the proximity zone, the accuracy and precision of the user location information may be improved, relative to the use of only coarse position data.

In some implementations, the detection component may obtain device identification data associated with the user device, including media access control (MAC) address, probe requests, device fingerprinting, behavioral data (e.g., movement data from multiple interactions with the user device), received signal strength, or the like. Additionally, or alternatively, the detection component may obtain additional information associated with the user device, including proximity data associated with the user device, and/or historical information associated with the user device (e.g., information related to historical location information associated with the user device), among other examples. Additionally, or alternatively, the user device may transmit the device identification data to the user management module upon the detection component detecting the user device. Additionally, or alternatively, the user device may transmit the device identification data to the user management module in connection with the user device providing position data (e.g., coarse position data) to the user management module, as described herein.

In some implementations, the user management module may attempt to determine user information (e.g., a user profile) based on matching the device identification information with user information associated with the user device. In some implementations, the user management module may match the device identification with user information stored in a user profile repository. In some implementations, the device identification may be matched with user information, and the user management module may obtain (e.g., from the UI and content generation engine) a UI and content information that is personalized to the user associated with the user device. By matching the detected user device with the user information, the user management module may obtain personalized content information (e.g., text, graphics, animation, interaction elements, videos, or the like) for the user, as described herein. For example, the personalized content may be tailored to a user based on user preferences, user location information, predicted user path and/or user behavior, and/or historical information associated with the user, among other examples. Additionally, or alternatively, in an implementation in which the user device information is not matched to a user profile (e.g., the user is not associated with a user profile), the user device information may be used to determine a UI and content information that is generic and/or that is specific to a device type associated with the user device. For example, in a scenario in which the user device is a smartphone that utilizes a specific operating system, the UI and content information may be different than the content that is provided to users associated with a user device that utilizes a different operating system.

As shown by reference number 120, the user management module may obtain, from a UI and content generation engine, a UI and/or content information based on the determined user location. In some implementations, the user management module may obtain the UI and/or content information based on determining that the user device associated with the user is located within a proximity zone. For example, in a scenario in which a detection beacon associated with the campus café determines that a user device associated with a user is within a proximity zone associated with the campus café, the user management module may obtain a UI and content that provides content relevant to the cafe (e.g., a message indicating “Stop by the café for today's specials.”). Additionally, or alternatively, time stamp information may be utilized to obtain content information that relevant to the time of day associated with a user's location. For example, in a scenario in which the user is determined to be within a proximity zone associated with the cafe in a morning time period, the user management module may obtain and provide a menu associated with breakfast items in the café. Furthermore, by utilizing time stamp information associated with a user's location (e.g., including coarse location information and fine location information, as described herein), the system may allocate resources more efficiently by obtaining and providing content information to a user only when the time stamp information satisfies certain conditions. For example, in a scenario in which the user is determined to be located in a proximity zone associated with the café at a time when the café is closed, the user management module may refrain from obtaining and providing content information to the user.

As shown by reference number 122, the user management module may provide, and the user device may receive, the UI and content information obtained from the UI and content generation engine. For example, the UI may be configured for and/or adapted to the type of user device (e.g., mobile device, smartwatch, tablet, or the like) associated with the user. Similarly, the content information may include content (e.g., text, images, graphics, interactive content elements, and/or videos, among other examples) that is relevant to the user being located within the proximity zone (e.g., proximity content) and/or may include content that is relevant to the user's location within the proximity zone.

In some implementations, the user management module may receive updated position data associated with the user, and the user management module may obtain updated content information based on the updated position data. For example, in a scenario in which the user management module receives updated position data indicating that the user is moving toward the detection component and/or moving toward a point of interest (e.g., a café, a fitness center, and/or a retail shop, among other examples), the user management module may obtain updated content intended to encourage the user's interaction with the point of interest. Additionally, or alternatively, the described techniques may be utilized to provide content information and update content information based on the user's location within a proximity in combination with the user's location within an activation zone and/or the user's interaction with an interaction beacon, as described herein.

As shown in FIG. 1C, the described techniques may be utilized to determine fine location information associated with a user based on an interaction event. In some implementations, the interaction event may be determined based on an interaction between a user tag, associated with the user, and one or more interaction beacons. In some implementations, the fine location information may be determined based on the interaction event occurring in a proximity zone, and the proximity zone may be located with an activation zone.

As shown by reference number 124, a user may interact with an interaction beacon via a user tag. In some implementations, the user tag may be associated with a near-range wireless communication technology (e.g., NFC, Bluetooth low energy (BLE), Ultra-Wideband (UWB), radio frequency identification (RFID), or the like). For example, a user may tap a user tag (e.g., a user badge, a user identification card, a credit card, a debit card, an NFC-capable device, or the like) to interact with an interaction beacon (e.g., an NFC reader, a card reader, or the like). The interaction may trigger the system to capture a time stamp and/or additional coarse position data (e.g., geolocation data) and/or fine position data (e.g., proximity data), thereby enabling the system to determine the user's location with increasing accuracy, precision, and context. Additionally, or alternatively, the user may interact with an interaction beacon and/or a detection component via detection of biometric data (e.g., facial recognition, fingerprinting, or the like) associated with the user.

As shown by reference number 126, the interaction beacon may provide, and the user management module may receive, the interaction information based on the interaction between the user tag and the interaction beacon. As shown by reference number 128, the user management module may obtain user location information from a tracking module. Additionally, or alternatively, the interaction information may be used to obtain a user profile associated with the user device that was detected by a detection component and/or to obtain a user profile associated with the user device that was identified by coarse position data, as described herein. For example, in a scenario in which the user management module is unable to match user information received from the detection component and/or from coarse position data, with a user profile in the user profile repository, the user management module may determine a user profile associated with the user device based on identifying the user profile associated with the interaction (e.g., via a user tag) at the interaction beacon. For example, the detection component may determine that a user device is located in relatively close proximity to the interaction beacon, and based on the user profile associated with a user interaction at the interaction beacon, the user management module may match the user profile to the user device. As a result, by matching the user profile that is identified according to the user interaction, to the user profile associated with the user device, the system may increase the accuracy of tracking a user associated with a user profile (e.g., a known user).

As shown by reference number 130, the tracking module may determine a user location based on the interaction information provided by the interaction beacon. In some implementations, the tracking module may determine the user location by matching the interaction beacon (e.g., the location of the interaction) to a location associated with the interaction beacon. For example, in a scenario in which the interaction information is associated with an interaction beacon located in a campus café, the tracking module may determine that the user is located within a certain proximity to the interaction beacon located in the campus café. Additionally, the tracking module may determine the user location, and/or refine the determined user location, based on coarse location information associated with the user device of the user and/or based on proximity detection information associated with detection of the user device by the detection component.

In some implementations, the tracking module may track and/or store user location information as the user transitions through proximity zones, interacts with interaction beacons, and/or moves through different areas within an activation zone. For example, the tracking module may use coarse location information to track a user's location within an activation zone, and the tracking module may use fine location information to track a user's location relative to one or more proximity zones based on proximity events and/or interaction events occurring with respect to the one or more proximity zones. In some implementations, this tracking information may be utilized to determine user concentration and user interaction at certain locations. Similarly, this tracking information may be used to determine behavioral trends associated with user concentration and user interaction at certain locations over time and/or during certain time periods, thereby enabling future optimizations. For example, the tracking information may be utilized to determine one or more time periods during which user concentration is highest at the campus café, thereby enabling staffing at the café to be adjusted according to these time periods. Similarly, for example, the tracking information may be utilized to provide users with content elements intended to dissuade users from visiting the café during certain times, thereby reducing the probability that detection components at the café will experience network congestion and/or interference from a relatively high number of user devices.

Additionally, or alternatively, the tracking module may determine and/or provide location information associated with a user's location and/or interaction activity outside of the activation zone. In some implementations, a user may interact with an interaction beacon located outside of the activation zone and/or located at a location at which the user enters a proximity zone associated with a detection beacon located outside of the activation zone, and the tracking module may record time stamp information and coarse and/or fine position data associated with the interaction.

As shown by reference number 134, the user management module may obtain, from a UI and content generation engine, a UI and/or content information based on the determined user location. In some implementations, the user management module may obtain the UI and/or content information based on determining that the user device associated with the user has interacted with the interaction beacon. For example, in a scenario in which the user taps a user badge at a campus fitness center, the user management module may select content and a UI that provides content relevant to the fitness center (e.g., a message indicating “Welcome to the Fitness Center. Check the calendar for today's classes.”). Additionally, or alternatively, time stamp information may be utilized to obtain content information that is relevant to the time of day associated with a user location. For example, in a scenario in which the user interacts with a campus fitness center interaction beacon in the morning, the user management module may obtain and provide a schedule of morning classes in the fitness center. Furthermore, by utilizing time stamp information associated with a user's location (e.g., including coarse location information and fine location information, as described herein), the system may allocate resources more efficiently by obtaining and providing content information to a user only when the time stamp information satisfies certain conditions. For example, in a scenario in which the user is determined to be in relatively close proximity to the fitness center at a time when the fitness center is closed, the user management module may refrain from obtaining and providing content information to the user.

As shown by reference number 136, the user management module may provide, and the user device may receive, the UI and content information obtained from the UI and content generation engine. For example, the UI may be configured for and/or adapted to the type of user device (e.g., mobile device, smartwatch, tablet, or the like) associated with the user. Similarly, the content information may include content (e.g., text, images, graphics, interactive content elements, and/or videos, among other examples) that is relevant to the user interacting with an interaction beacon associated with a point of interest. In some implementations, the user management module may receive updated position data associated with the user, and the user management module may obtain updated content information based on the updated position data.

As shown in FIG. 1D, the described techniques may utilize location information associated with a user based on coarse location data and/or fine location data in order to determine a user location and/or to predict a user path. In some implementations, the coarse location may be associated with geolocation information for a user device associated with the user, as described herein. Additionally, the fine location information may be associated with a proximity event and/or an interaction event associated with the user, as described herein.

As shown by reference number 138, the user management module may receive, from the user device, a detection component, and/or an interaction beacon, location data associated with the user. As shown by reference number 140, the user management module may obtain, from a tracking module, user location information and predicted path information.

As shown by reference number 142, the tracking module may determine user location and store tracking information associated with the user location over one or more periods of time. In some implementations, the tracking module may determine a user location based on the coarse position data and/or the fine position data, as described herein.

As shown by reference number 144, the system may obtain a predicted user path based on the tracking information. For example, user location, time stamp information associated with user location, and user behavior (e.g., historical user data associated with tracking of one or more users) may be used to identify the movement path of a user and/or predict the movement path of a user using artificial intelligence/machine learning (AI/ML) techniques described herein, thereby enabling content delivery to be customized along the movement path of the user. For example, such customization may be used to provide navigational directions that instruct a user along the user's path to a destination, and such directions may be updated and adapted to the user and the position of the user. Similarly, such customization may be used to provide content encouraging a user to visit certain points of interest along the predicted path of the user. For example, such content may be dynamically updated to encourage users to visit certain points of interest based on congestion levels and/or time constraints. Additionally, such customization may enable personalization of the UI and/or content elements based on predicted user preferences and/or behaviors. For example, the system may utilize predicted behavior and/or user path information to deliver content to a user that suggests a quiet space for studying and/or a lunch location with relatively low congestion.

Additionally, the system may track the user based on the determined location information in order to generate vector data (e.g., path data, movement data, behavior data, or the like) that may be utilized to obtain decision information (e.g., conditions for providing and updating content to the user device). Furthermore, the system may receive user identification information associated with the user to determine a user profile (e.g., including historical information associated with the user) for the user, and the user profile may be associated with the decision information for selecting content information for delivery to the user device. Additionally, the system may receive user device identification data for the user device associated with the user to determine a user profile associated with the user, and the user profile may be associated with the decision information for selecting content information to deliver to the user device.

As shown by reference number 146, the user management module may obtain, from a UI and content generation engine, a UI and/or content information based on the determined user location and the predicted path of the user. For example, in a scenario in which the predicted path of a user indicates that the user is likely to be near a campus café during a morning time period, the system may provide customized messages to the user device, encouraging the user to visit the campus café in order to purchase breakfast items.

As shown by reference number 148, the user management module may provide, and the user device may receive, the UI and content information obtained from the UI and content generation engine. For example, the UI may be configured for and/or adapted to the type of user device (e.g., mobile device, smartwatch, tablet, or the like) associated with the user. Similarly, the content information may include content (e.g., text, images, graphics, interactive content elements, and/or videos, among other examples) that is relevant to the predicted path of the user. In some implementations, the user management module may receive updated position data associated with the user, and the user management module may obtain updated content information based on the updated position data.

In some implementations, the user management module may provide content to an augmented reality (AR) and/or virtual reality (VR) component associated with the user device. For example, by using AR and/or VR components, the system may deliver visual representations of a navigational path, directing the user to one or more points of interest. Similarly, the user management module may provide audio content, including voice command navigation information for navigation to one or more points of interest. Additionally, the user device may be configured to store information associated with the provided content and the UI in order to access time-and location-based content in areas with poor wireless connectivity and/or poor geolocation capabilities.

In some implementations, location information associated with a user may be utilized for access control (e.g., locking and/or unlocking doors), content personalization on third-party displays (e.g., billboards, common-area display devices, or the like), and/or automated services (e.g., pre-ordering a coffee, turning on/off lighting, or the like), among other examples.

As described herein, some implementations may enable dynamic content delivery based on a time and a location associated with a user. Furthermore, the system may generate behavior information based on the tracking of the user, obtain predicted path and/or behavior information associated with the user, obtain updated decision information based on the predicted path and/or behavior information, and select an updated one or more content elements based on the updated decision information. As a result, the system may deliver content that is customized to a user's location at a certain time and may be personalized to the user. Furthermore, by utilizing a layered, integrated approach to determining a user location, the described techniques may improve accuracy and precision and reduce latency for determining user location. For example, the layered, integrated architecture may enable seamless transitions of user tracking across broad geographic areas, micro-locations, and precise interaction points of interest, without loss of context or performance. Accordingly, by accurately and continuously monitoring users across multiple zones, the system may reduce resource usage (e.g., network resources, power resources, or the like) compared to periodic and/or discontinuous tracking that may require the system to repeatedly identify, acquire, and/or reacquire users. Additionally, by tracking and/or predicting movement paths of one or more users in a geographic area, the system may efficiently allocate network and/or power resources in areas of relatively high and/or relatively low congestion.

Similarly, by adapting and delivering content based on a movement path and/or behavior information associated with the user over a period of time, the system may deliver unique, location-specific content to the user at different points along a movement path and/or according to a predicted movement path. Furthermore, by utilizing time stamp information associated with a user's location (e.g., including coarse location information and fine location information), the system may allocate resources more efficiently by obtaining and providing content information to a user only when the time stamp information satisfies certain conditions (e.g., when points of interest are open and/or are associated with relatively low congestion levels, among other examples). Similarly, the system may deliver (or refrain from delivering) content to one or more user devices that encourages users to move to certain points of interest, thereby enabling the system to utilize congestion mitigation strategies.

As indicated above, FIGS. 1A-1D are provided as an example. Other examples may differ from what is described with regard to FIGS. 1A-1D.

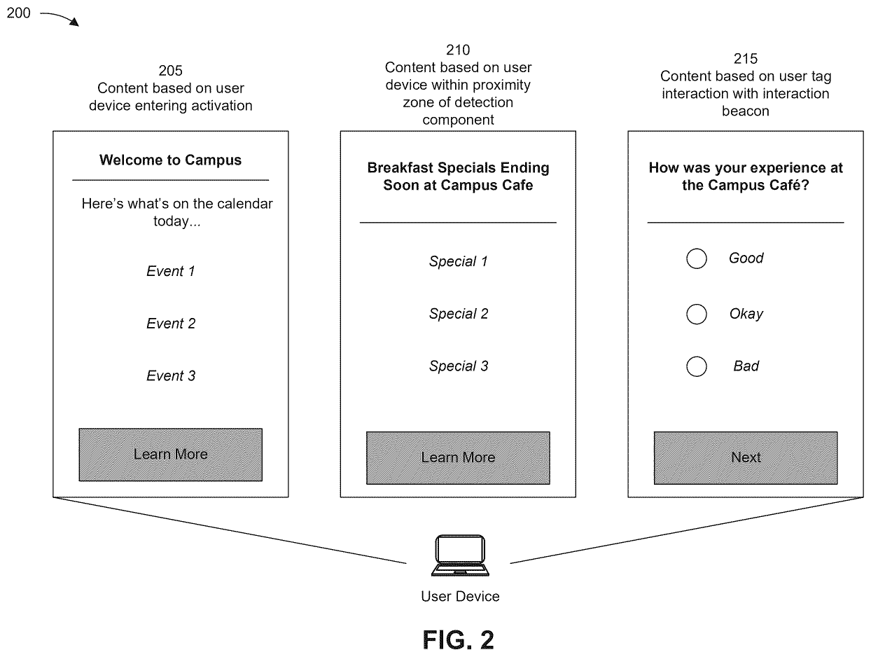

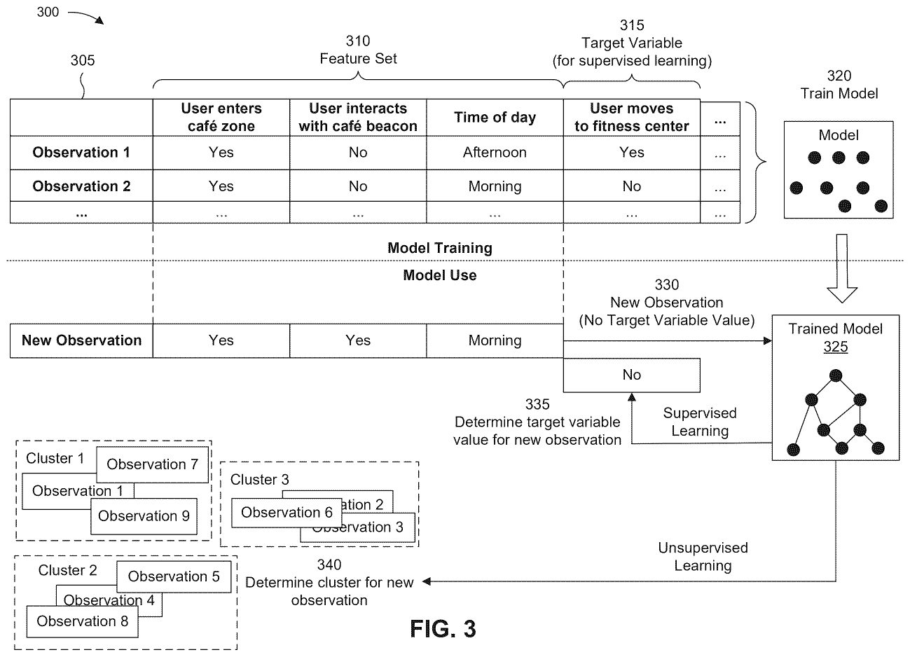

FIG. 2 is a diagram of an example 200 associated with time-and location-based content delivery. As shown in FIG. 2, example 200 includes a user device and a UI associated with the user device. The user device is described in more detail in connection with FIGS. 3 and 4. Additionally, FIG. 2 is a particular example implementation of FIGS. 1A-1D in a content delivery use case. As shown in FIG. 2, a set of UIs for a user may include UI elements for points of interest and location-specific content in a time-and location-based content delivery system.

As shown by reference number 205, the system may determine that the user has entered an activation zone, and the system may be configured to provide a UI and content information that is relevant to the user's location. For example, the UI and content information may include a “Welcome to Campus” message and information concerning calendar events associated with one or more locations on campus. Additionally, the UI may include an interactive content element enabling the user to request more information by interacting with the content element.

As shown by reference number 210, the system may determine that the user is within a proximity zone (e.g., based on determining that the user's proximity to a detection component satisfies one or more proximity conditions), and the system may be configured to provide a UI and content information that is relevant to a point of interest associated with the proximity zone. For example, in a scenario in which the user is located within a proximity zone associated with a campus café, the UI may display content information indicating a “Breakfast Specials Ending Soon at Campus Café” message as well as information concerning menu items associated with a café location. Additionally, the UI may include an interactive content element enabling the user to request more information by interacting with the content element.

Additionally, or alternatively, time stamp information may be utilized to obtain content information that is relevant to the time of day associated with a user location. For example, in a scenario in which the user is located within a proximity zone associated with the campus café during a morning time period, the user management module may obtain content information that provides content relevant to the user entering at this time of day (e.g., a message indicating “Breakfast specials are ending soon at the café.”). Furthermore, by utilizing time stamp information associated with the user's location (e.g., including coarse location information and fine location information, as described herein), the system may allocate resources more efficiently by obtaining and providing content information to the user only when the time stamp information satisfies certain conditions. For example, in a scenario in which the user is in relatively close proximity to the campus café, the system may only provide content information to the user during time periods when the campus café is open.

As shown by reference number 215, the system may determine that the user has interacted with an interaction beacon (e.g., via a user tag), and the system may be configured to provide a UI and content information that is relevant to a point of interest associated with the interaction beacon. For example, the user may a user badge, credit card, NFC tag, or the like at an interaction beacon associated with the campus café, and the UI may display content soliciting feedback on the user's experience. Additionally, the UI may include interactive content elements enabling the user to submit feedback by interacting with the content element.

As described herein, some implementations may enable dynamic content delivery based on a time and a location associated with a user. As a result, the system may deliver content that is customized to a user's location at a certain time and may be personalized to the user. Furthermore, by utilizing a layered, integrated approach to determining a user location, the described techniques may improve accuracy and precision and reduce latency for determining user location. For example, the layered, integrated architecture may enable seamless transitions of user tracking across broad geographic areas, micro-locations, and precise interaction points of interest, without loss of context or performance. Accordingly, by accurately and continuously monitoring users across multiple zones, the system may reduce resource usage (e.g., network resources, power resources, or the like) relative to periodic and/or discontinuous tracking that may require the system to repeatedly identify, acquire, and/or reacquire users. Additionally, by tracking and/or predicting movement paths of one or more users in a geographic area, the system may efficiently allocate network and/or power resources in areas of relatively high and/or relatively low congestion. Furthermore, by utilizing time stamp information associated with a user's location (e.g., including coarse location information and fine location information), the system may allocate resources more efficiently by obtaining and providing content information to a user only when the time stamp information satisfies certain conditions (e.g., when points of interest are open and/or are associated with relatively low congestion levels, among other examples). Similarly, the system may deliver (or refrain from delivering) content to one or more user devices that encourages users to move to certain points of interest, thereby enabling the system to attempt congestion mitigation strategies.

As indicated above, FIG. 2 is provided as an example. Other examples may differ from what is described with regard to FIG. 2.

FIG. 3 is a diagram of an example 300 of training and using a machine learning model in connection with a time-and location-based content delivery system. The machine learning model training and usage described herein may be performed using a machine learning system. The machine learning system may include or may be included in a computing device, a server, a cloud computing environment, or the like, such as the server and/or the user device described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from a server, a user device, a user context data repository, and/or another suitable data source, as described elsewhere herein.

As shown by reference number 310, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from a server, a user device, a user context data repository, and/or another suitable data source. For example, the machine learning system may identify a feature set (e.g., one or more features and/or feature values) by extracting the feature set from structured data, by performing natural language processing and/or computer vision processing to extract the feature set from unstructured data, and/or by receiving input from an operator.

As an example, a feature set for a set of observations may include a first feature of User enters café zone, a second feature of User interacts with beacon, a third feature of Time of day, and so on. As shown, for a first observation, the first feature may have a value of Yes (e.g., indicating that the user has entered a proximity zone associated with the cafe), the second feature may have a value of No (e.g., indicating that the user has not interacted with an interaction beacon associated with the café), the third feature may have a value of Afternoon (e.g., indicating the time period in which the system has made a location determination and/or has obtained location tracking data associated with the user), and so on. These features and feature values are provided as examples, and may differ in other examples. For example, the feature set may include one or more of the following features: user speed (e.g., stationary, fast, slow), user vector (e.g., direction of travel associated with a user), facial tracking and/or eye tracking data, navigation utilization (e.g., utilizing navigation prompts on a user device and/or associated with navigation prompts in an environment), and/or quantity of tracking methods (e.g., coarse tracking, fine tracking, or the like), among other examples.

As shown by reference number 315, the set of observations may be associated with a target variable. The target variable may represent a variable having a binary attribute (e.g., yes or no), may represent a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is User moves to fitness center, which has a value of Yes for the first observation.

The feature set and target variable described above are provided as examples, and other examples may differ from what is described above. For example, for a target variable of User interacts with fitness center beacon, the feature set may include a No option (e.g., the user did not interact with an interaction beacon associated with the fitness center), a Yes option (e.g., the user interacted with an interaction beacon associated with the fitness center), or the like.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on historical data indicating whether a user has entered a café zone, historical interaction between a user and a café beacon, a time of day associated with location and/or interaction data, or the like.

As shown by reference number 330, the machine learning system may apply the trained machine learning model 325 to a new observation, such as by receiving a new observation and inputting the new observation to the trained machine learning model 325. As shown, the new observation may include a first feature of Yes (e.g., indicating that the user has entered a proximity zone associated with the cafe), a second feature of No (e.g., indicating that the user has not interacted with an interaction beacon associated with the café), and a third feature of Morning (e.g., indicating the time period in which the system has made a location determination and/or has obtained location tracking data associated with the user), and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of No for the target variable of User moves to fitness center for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to refrain from providing the user with content relating to the fitness center, as the user is unlikely to be interested in such content at the time. The first automated action may include, for example, skipping the delivery of content relating to the fitness center, where such content would normally be displayed to users in the café zone.

As another example, if the machine learning system were to predict a value of Yes for the target variable of User moves to fitness center, then the machine learning system may provide a second (e.g., different) recommendation (e.g., recommending that the server provide the user with content relating to the fitness center), and/or may perform or cause performance of a second (e.g., different) automated action (e.g., deliver content associated with the fitness center).

In some implementations, the trained machine learning model 325 may classify (e.g., cluster) the new observation in a cluster, as shown by reference number 340. The observations within a cluster may have a threshold degree of similarity. As an example, if the machine learning system classifies the new observation in a first cluster (e.g., User moves to fitness center), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., user does not move to fitness center), then the machine learning system may provide a second (e.g., different) recommendation, such as the second recommendation described above, and/or may perform or cause performance of a second (e.g., different) automated action, such as the second automated action described above.

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include information that is obtained or otherwise gathered via an instance of delivering content based on time and location information associated with a user.

In this way, the machine learning system may apply a rigorous and automated process to determine whether and how to deliver content based on time and location information associated with a user. The machine learning system may enable recognition and/or identification of tens, hundreds, thousands, or millions of features and/or feature values for tens, hundreds, thousands, or millions of observations, thereby increasing accuracy and consistency and reducing delay associated with delivering content based on time and location information associated with a user, relative to requiring computing resources to be allocated for tens, hundreds, or thousands of operators to manually provide and update content based on time and location information associated with a user.

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, environment 400 may include a user device 410, an interaction beacon 420, a detection component 430, a server 440, and a network 450. Devices of environment 400 may interconnect via wired connections, wireless connections, or a combination of wired and wireless connections.

The user device 410 may include one or more devices capable of receiving, generating, storing, processing, and/or providing information associated with time-and location-based content delivery, as described elsewhere herein. The user device 410 may include a communication device and/or a computing device. For example, the user device 410 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The interaction beacon 420 may include one or more devices capable of receiving, generating, storing, processing, and/or providing information associated with time-and location-based content delivery, as described elsewhere herein. The interaction beacon 420 may include a communication device and/or a computing device. For example, the interaction beacon 420 may include a wireless communication device, a wireless beacon, and/or a passive wireless detection device that operates on one or more near-range wireless communication standards (e.g., NFC, BLE, UWB, RFID, or the like), and/or one or more licensed and/or unlicensed wireless communication spectrums, or a similar type of device.

The detection component 430 may include one or more devices capable of receiving, generating, storing, processing, and/or providing information associated with time-and location-based content delivery, as described elsewhere herein. The detection component 430 may include a communication device and/or a computing device. For example, the detection component 430 may include a wireless communication device, a wireless beacon, and/or a passive wireless detection device that operates on one or more wireless communication standards (e.g., WiFi, Bluetooth, Zigbee, or the like), and/or one or more licensed and/or unlicensed wireless communication spectrums, or a similar type of device.

The server 440 may include one or more devices capable of receiving, generating, storing, processing, providing, and/or routing information associated with time-and location-based content delivery, as described elsewhere herein. The server 440 may include a communication device and/or a computing device. For example, the server 440 may include a server, such as an application server, a client server, a web server, a database server, a host server, a proxy server, a virtual server (e.g., executing on computing hardware), or a server in a cloud computing system. In some implementations, the server 440 may include computing hardware used in a cloud computing environment, such as one or more serverless components (e.g., one or more serverless functions).

The network 450 may include one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with time-and location-based content delivery. The device 500 corresponds to one or more of the user device 410, the interaction beacon 420, the detection component 430, and/or the server 440. In some implementations, the user device 410, the interaction beacon 420, the detection component 430, and/or the server 440 include one or more devices 500 and/or one or more components of the device 500. In the example shown in FIG. 5, the device 500 includes a bus 510, a processor 520, a memory 530, an input component 540, an output component 550, and/or a communication component 560.

The bus 510 includes one or more components that enable wired and/or wireless communication among the components of the device 500. The bus 510 couples together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 includes a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 includes one or more processors capable of being programmed to perform one or more operations or processes described elsewhere herein.

The memory 530 includes volatile and/or nonvolatile memory, such as random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). In some implementations, the memory 530 is a non-transitory computer-readable medium. The memory 530 stores information, one or more instructions, and/or software (e.g., one or more software applications) related to the operation of the device 500. In some implementations, the memory 530 includes one or more memories that are coupled (e.g., communicatively coupled) to one or more processors (e.g., processor 520), such as via the bus 510. Communicative coupling between a processor 520 and a memory 530 enables the processor 520 to read and/or process information stored in the memory 530 and/or to store information in the memory 530.

The input component 540 enables the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 enables the device 500 to provide output, such as via a display, a speaker, and/or a light-emitting diode. The communication component 560 enables the device 500 to communicate with other devices via a wired connection and/or a wireless connection. For example, the communication component 560 may include a receiver, a transmitter, a transceiver, a modem, a network interface card, and/or an antenna.

In some implementations, the device 500 performs one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry is used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

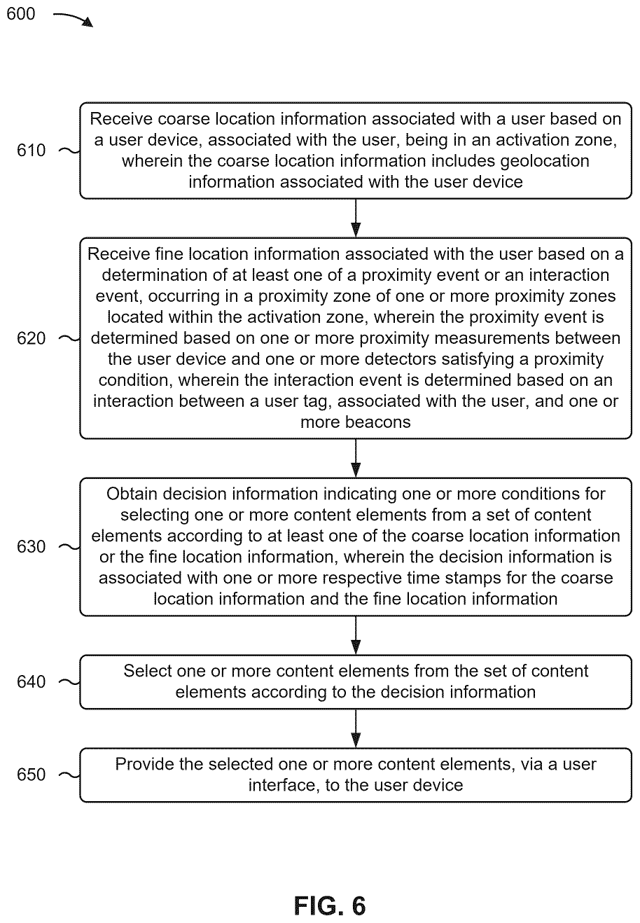

FIG. 6 is a flowchart of an example process 600 associated with time-and location-based content delivery. In some implementations, one or more process blocks of FIG. 6 may be performed by the server 440. In some implementations, one or more process blocks of FIG. 6 may be performed by another device or a group of devices separate from or including the server 440, such as the user device 410, the interaction beacon 420, and/or the detection component 430. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving coarse location information associated with a user based on a user device, associated with the user, being in an activation zone (block 610). For example, the server 440 (e.g., using processor 520, memory 530, input component 540, and/or communication component 560) may receive coarse location information associated with a user based on a user device, associated with the user, being in an activation zone, as described above in connection with reference number 102 of FIG. 1A and/or reference number 138 of FIG. 1D. As an example, the system may receive coarse location information indicating that a user has entered a geolocation area associated with a geographic area of a campus. In some implementations, the coarse location information includes geolocation information associated with the user device. For example, the system may receive GPS and/or similar geolocation information for the user device associated with the user.

As further shown in FIG. 6, process 600 may include receiving fine location information associated with the user based on a determination of at least one of a proximity event or an interaction event, occurring in a proximity zone of one or more proximity zones located within the activation zone (block 620). For example, the server 440 (e.g., using processor 520, memory 530, input component 540, and/or communication component 560) may receive fine location information associated with the user based on a determination of at least one of a proximity event or an interaction event, occurring in a proximity zone of one or more proximity zones located within the activation zone, as described above in connection with reference number 114 of FIG. 1B reference number 126 of FIG. 1C, and/or reference number 138 of FIG. 1D. As an example, the system may receive information indicating that a user has been detected within a proximity zone located on the campus, and/or that a user has interacted with a point of interest located on the campus. In some implementations, the proximity event is determined based on one or more proximity measurements between the user device and one or more detectors satisfying a proximity condition. For example, a detection beacon associated with a campus café determines that a user device associated with a user is located within a certain proximity to the campus café. In some implementations, the interaction event is determined based on an interaction between a user tag, associated with the user, and one or more beacons. For example, an interaction beacon associated with the campus café may determine a user location based on the user tapping a user badge to the interaction beacon.

As further shown in FIG. 6, process 600 may include obtaining decision information indicating one or more conditions for selecting one or more content elements from a set of content elements according to at least one of the coarse location information or the fine location information (block 630). For example, the server 440 (e.g., using processor 520 and/or memory 530) may obtain decision information indicating one or more conditions for selecting one or more content elements from a set of content elements according to at least one of the coarse location information or the fine location information, as described above in connection with reference number 106 of FIG. 1A, reference number 118 of FIG. 1B, reference number 130 of FIG. 1C, and/or reference number 142 of FIG. 1D. As an example, the system may determine a user location and may provide user location information that may be utilized to determine content information to provide to the user based on the user location information. In some implementations, the decision information is associated with one or more respective time stamps for the coarse location information and the fine location information. For example, in a scenario in which time stamp information indicates that the user enters the campus in the morning, the user management module may obtain content information that provides content relevant to the user entering at that time of day (e.g., a message indicating “Welcome to Campus. Breakfast specials are ending soon at the café.”).

As further shown in FIG. 6, process 600 may include selecting one or more content elements from the set of content elements according to the decision information (block 640). For example, the server 440 (e.g., using processor 520 and/or memory 530) may select one or more content elements from the set of content elements according to the decision information, as described above in connection with reference number 108 of FIG. 1A, reference number 120 of FIG. 1B, reference number 134 of FIG. 1C, and/or reference number 146 of FIG. 1D. As an example, in a scenario in which the user location is determined to be within a proximity zone associated with the campus café, the system may select content that is relevant to the campus café (e.g., menus, daily specials, or the like).

As further shown in FIG. 6, process 600 may include providing the selected one or more content elements, via a UI, to the user device (block 650). For example, the server 440 (e.g., using processor 520 and/or memory 530) may provide the selected one or more content elements, via a UI, to the user device, as described above in connection with reference number 110 of FIG. 1A, reference number 122 of FIG. 1B, reference number 136 of FIG. 1C, and/or reference number 148 of FIG. 1D. As an example, the system may provide a user with content relevant to a campus café based on determining that the user is within a proximity zone associated with the campus café and/or based on determining that the user has interacted with an interaction beacon associated with the campus café.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A, 1B, 1C, 1D, and 2. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for time-and location-based content delivery, the system comprising:
one or more memories; and
one or more processors, communicatively coupled to the one or more memories, configured to:
receive coarse location information associated with a user based on a user device, associated with the user, being in an activation zone,
wherein the coarse location information includes geolocation information associated with the user device;
receive fine location information associated with the user based on a determination of at least one of a proximity event or an interaction event, occurring in a proximity zone of one or more proximity zones located within the activation zone,
wherein the proximity event is determined based on one or more proximity measurements between the user device and one or more detectors satisfying a proximity condition,
wherein the interaction event is determined based on an interaction between a user tag, associated with the user, and one or more beacons;
obtain decision information indicating one or more conditions for selecting one or more content elements from a set of content elements according to at least one of the coarse location information or the fine location information,
wherein the decision information is associated with one or more respective time stamps for the coarse location information and the fine location information;
select one or more content elements from the set of content elements according to the decision information; and
provide the selected one or more content elements, via a user interface, to the user device.

2. The system of claim 1, wherein the one or more processors, to select the one or more content elements from the set of content elements according to the decision information, are configured to:
select one or more activation content elements based on the user being located in the activation zone and not being located in a proximity zone of the one or more proximity zones.

3. The system of claim 1, wherein the one or more processors, to select the one or more content elements from the set of content elements according to the decision information, are configured to:
select one or more proximity content elements based on the occurrence of a proximity event.

4. The system of claim 1, wherein the one or more processors, to select the one or more content elements from the set of content elements according to the decision information, are configured to:
select one or more interaction content elements based on the occurrence of an interaction event.

5. The system of claim 1, wherein the one or more processors are further configured to:
perform tracking of the user, over a period of time, based on the coarse location information and the fine location information;
generate vector data based on the tracking of the user;
obtain updated decision information based on the vector data;
select an updated one or more content elements from the set of content elements based on the updated decision information; and
provide the updated one or more content elements, via the user interface, to the user device.

6. The system of claim 1, wherein the one or more processors are further configured to:
perform tracking of the user over a period of time, based on the coarse location information and the fine location information;
generate behavior information based on the tracking of the user;
obtain predicted behavior information associated with the user,
wherein the predicted behavior information is based on the behavior information;
obtain updated decision information based on the predicted behavior information;
select an updated one or more content elements from the set of content elements based on the updated decision information; and
provide the updated one or more content elements, via the user interface, to the user device.

7. The system of claim 1, wherein the one or more processors are further configured to:
receive at least one of user device identity data associated with the user device or user tag identity data associated with the user tag;
obtain a set of user profiles,
wherein each user profile of the set of user profiles is associated with identity data; and
determine a user profile from the set of user profiles based on a comparison between the identity data and at least one of the user device identity data or the user tag identity data,
wherein the decision information is associated with the determined user profile.

8. The system of claim 1, wherein the one or more processors are further configured to:
receive input information from the user device;
wherein the input information is related to the provided content elements;
obtain updated decision information based on the input information;
select an updated one or more content elements from the set of content elements based on the updated decision information; and
provide the updated one or more content elements, via the user interface, to the user device.

9. The system of claim 1, wherein the one or more processors are further configured to:
receive updated user location information,
wherein the updated user location information includes updated coarse location information and updated fine location information;
obtain updated decision information based on the updated user location information;
select an updated one or more content elements from the set of content elements based on the updated decision information; and
provide the updated one or more content elements, via the user interface, to the user device.

10. A method for time-and location-based content delivery, comprising:
receiving, by a system, coarse location information associated with a user based on a user device, associated with the user, being in an activation zone,
wherein the coarse location information includes geolocation information associated with the user device;
receiving, by the system, fine location information associated with the user based on a determination of at least one of a proximity event or an interaction event, occurring in a proximity zone of one or more proximity zones located within the activation zone,
wherein the proximity event is determined based on one or more proximity measurements between the user device and one or more detectors satisfying a proximity condition,
wherein the interaction event is determined based on an interaction between a user tag, associated with the user, and one or more beacons;
obtaining, by the system, decision information indicating one or more conditions for selecting one or more content elements from a set of content elements according to at least one of the coarse location information or the fine location information,
wherein the decision information is associated with one or more respective time stamps for the coarse location information and the fine location information;
selecting, by the system, one or more content elements from the set of content elements according to the decision information; and
providing, by the system, the selected one or more content elements, via a user interface, to the user device.

11. The method of claim 10, further comprising:
performing tracking of the user, over a period of time, based on the coarse location information and the fine location information;
generating vector data based on the tracking of the user;
obtaining updated decision information based on the vector data;
selecting an updated one or more content elements from the set of content elements based on the updated decision information; and
providing the updated one or more content elements, via the user interface, to the user device.

12. The method of claim 10, further comprising:
performing tracking of the user over a period of time, based on the coarse location information and the fine location information;
generating behavior information based on the tracking of the user;
obtaining predicted behavior information associated with the user,
wherein the predicted behavior information is based on the behavior information;
obtaining updated decision information based on the predicted behavior information;
selecting an updated one or more content elements from the set of content elements based on the updated decision information; and
providing the updated one or more content elements, via the user interface, to the user device.

13. The method of claim 10, further comprising:
receiving at least one of user device identity data associated with the user device or user tag identity data associated with the user tag;
obtaining a set of user profiles,
wherein each user profile of the set of user profiles is associated with identity data; and
determining a user profile from the set of user profiles based on a comparison between the identity data and at least one of the user device identity data or the user tag identity data,
wherein the decision information is associated with the determined user profile.

14. The method of claim 10, further comprising:
receiving input information from the user device;
wherein the input information is related to the provided content elements;
obtaining updated decision information based on the input information;
selecting an updated one or more content elements from the set of content elements based on the updated decision information; and
providing the updated one or more content elements, via the user interface, to the user device.

15. The method of claim 10, further comprising:
receiving updated user location information,
wherein the updated user location information includes updated coarse location information and updated fine location information;
obtaining updated decision information based on the updated user location information;
selecting an updated one or more content elements from the set of content elements based on the updated decision information; and
providing the updated one or more content elements, via the user interface, to the user device.

16. A non-transitory computer-readable medium storing a set of instructions, the set of instructions comprising:
one or more instructions that, when executed by one or more processors of a system, cause the system to:
receive coarse location information associated with a user based on a user device, associated with the user, being in an activation zone,
wherein the coarse location information includes geolocation information associated with the user device;
receive fine location information associated with the user based on a determination of at least one of a proximity event or an interaction event, occurring in a proximity zone of one or more proximity zones located within the activation zone,
wherein the proximity event is determined based on one or more proximity measurements between the user device and one or more detectors satisfying a proximity condition,
wherein the interaction event is determined based on an interaction between a user tag, associated with the user, and one or more beacons;
obtain decision information indicating one or more conditions for selecting one or more content elements from a set of content elements according to at least one of the coarse location information or the fine location information,
wherein the decision information is associated with one or more respective time stamps for the coarse location information and the fine location information;
select one or more content elements from the set of content elements according to the decision information; and
provide the selected one or more content elements, via a user interface, to the user device.

17. The non-transitory computer-readable medium of claim 16, wherein the one or more instructions, that cause the system to select the one or more content elements from the set of content elements according to the decision information, cause the system to:
select one or more activation content elements based on the user being located in the activation zone and not being located in a proximity zone of the one or more proximity zones.

18. The non-transitory computer-readable medium of claim 16, wherein the one or more instructions, that cause the system to select the one or more content elements from the set of content elements according to the decision information, cause the system to:
select one or more proximity content elements based on the occurrence of a proximity event.

19. The non-transitory computer-readable medium of claim 16, wherein the one or more instructions, that cause the system to select the one or more content elements from the set of content elements according to the decision information, cause the system to:
select one or more interaction content elements based on the occurrence of an interaction event.

20. The non-transitory computer-readable medium of claim 16, wherein the one or more instructions further cause the system to:
perform tracking of the user over a period of time, based on the coarse location information and
the fine location information;
generate behavior information based on the tracking of the user;
obtain predicted behavior information associated with the user,
wherein the predicted behavior information is based on the behavior information;
obtain updated decision information based on the predicted behavior information;
select an updated one or more content elements from the set of content elements based on the updated decision information; and
provide the updated one or more content elements, via the user interface, to the user device.
